(19) United States
(12) Patent Application Publication
(10) Pub. No.: US 2003/0138537 A1
(43) Pub. Date: Jul. 24, 2003

(54) Methods of preparing improved water-soluble extracts containing antioxidants and uses thereof

(76) Inventors: David T. Bailey, Boulder, CO (US); Rebecca L. Nichols, Broomfield, CO (US); Steven L. Richheimer, Westminster, CO (US)

Correspondence Address: Steven C. Petersen, Hogan & Hartson, LLP, Suite 1500, 1200 17th Street, Denver, CO, 80202, US

(21) Appl. No.: 10/025,479

(22) Filed: Dec. 19, 2001

(51) Int. Cl. A23B 4/00

(52) U.S. Cl. 426/542

(57) ABSTRACT

The present invention provides an improved process for preparing a water-soluble extract containing one or more naturally occurring antioxidants (from plant materials from the Labiatae family. The process produces an extract that is essentially odorless, flavorless and colorless when used at a concentration between about 5 and 1000 ppm.

### FIELD OF THE INVENTION

The invention provides a process for the production of improved water-soluble plant extracts having neutral flavor, odor, and color when used at the recommended dosage levels for use as antioxidants and as flavor stabilizers and/or enhancers.

### BACKGROUND OF THE INVENTION

Antioxidants serve in a number of important commercial applications, especially as ingredients in food products susceptible to degeneration, in one form or another, due to oxidation. “Antioxidants” are defined by the Food and Drug Administration (21 CFR § 170.3) as “substances used to preserve food by retarding deterioration, rancidity, or discoloration due to oxidation.” Commercial applications include use in processed meat and poultry, salad dressings, beverages, seasonings, snacks, nuts, soup bases, edible fats and oils, natural foods, pet foods and packaging. In addition to foods, antioxidants have been used to prevent oxidation in various cosmetic and toiletry products and in medicinal or pharmaceutical preparations. The primary purpose in each of these applications is to prevent deterioration of desirable product characteristics by inhibiting oxidation.

More recently, antioxidants in food sources and dietary supplements have received attention for their potential to prevent or delay the onset of certain cancers and other chronic health conditions including heart disease, cataracts and aging. The theory is that, by preventing oxidation, these materials inhibit the formation of oxygen containing free radicals that are believed to play a significant role in initiation of these conditions and other chronic disorders.

The use of spices to prevent food deterioration as well as to impart flavor has been known for centuries. Because of their cost and availability, however, synthetic antioxidants, such as butylated hydroxyanisole (BHA) and butylated hydroxytoluene (BHT), have been predominant in commercial food preparation. These antioxidants have proven quite effective. However, significant questions have been raised about their safety. For example, BHA has been identified as a “carcinogen” by the International Agency for Research on Cancer and has been banned in Europe. The safety of BHT has also been questioned.

Because of these concerns, there has been an increasing interest in the use of naturally occurring antioxidants in food preparation. These include compounds which are found in and can be isolated from certain spices, particularly rosemary, sage, thyme and oregano. Recent tests indicate that such compounds are significantly more effective than other naturally occurring antioxidants, as well as certain synthetic antioxidants, such as BHA and BHT. Antioxidants prepared from rosemary or sage extracts have certain additional advantages including the fact that they are stable at high temperatures compared to other antioxidants. In addition, many consumers perceive that naturally occurring antioxidants are inherently safer than synthetic “preservatives.”

Unfortunately, antioxidants extracted from naturally occurring materials often exhibit flavors, odors, and/or colors that are undesirable in many applications. Accordingly, significant efforts have been expended to find commercially acceptable ways to extract antioxidants from these plant sources and to separate them from other naturally occurring compounds that give rise to these undesirable characteristics. Many processes have been tried but suffer from various defects, such as cost, the lack of selectivity in isolating the antioxidant, the use of undesirable solvents in the isolation process, or poor yield.

Apart from steam distillation and molecular distillation, the main conventional method for isolating natural antioxidants from plant materials is solvent extraction for which polar extracting agents such as methanol (see U.S. Pat. No. 3,950,266) but also non-polar extracting agents such as hexane or pentane are particularly recommended.

Disadvantages of these known methods include the relatively high technical complexity and the fact that conventional solvents often have a low selectivity with regard to those constituents that are particularly effective antioxidants. Hence the extracts obtained in this way do not always demonstrate as strong an antioxidative activity as do the synthetic compounds, and in addition are not sufficiently neutral in flavor or odor.

U.S. Pat. No. 5,017,397 describes a method in which active antioxidative substances are isolated from spices with the aid of supercritical CO₂. By this process an extract is obtained at 350 to 1000 bar and at a temperature of 31° to 120° C., and subsequently separated into two fractions comprising the essential oil and the antioxidative substances. A disadvantage of this process is that it has to be carried out at relatively high pressures, which can only be realized with extreme difficulty in technical plants, and consequently the fractionation is technically quite difficult and expensive. The extract obtained in this way is not sufficiently neutral in flavor and color for many application purposes.

Kahless, et al. (U.S. Pat. No. 5,433,949) describe a method of extracting antioxidants from rosemary, thyme, sage and oregano by first extracting the plant material with compressed carbon dioxide, followed by re-extracting the extract with a polar alcoholic solvent and/or non-polar hydrocarbons. The solvent extract is then treated with active carbon to remove residual color.

Other methods for isolating antioxidants from plant materials, such as that described in U.S. Pat. No. 5,209,870 to Todd, Jr. and U.S. Pat. No. 5,859,293 to Bailey, et al., provide methods of extracting antioxidants from rosemary or sage into alkaline solutions. These methods, however, are selective for carnosic acid, which is highly insoluble in water.

U.S. Pat. No. 5,908,650 to Lenoble, et al., describes a process of preparing a water-soluble rosemary extract (“WSRE”) by extracting rosemary leaves into water and acidifying the extract. The acidified crude extract is then loaded onto a reversed-phase media to remove undesirable components (e.g., sugars, salts, and insoluble compounds). The desired fraction is then washed off the column. The isolated product, however, contains a significant amount of flavonoid glucuronides and glycosides in addition to the antioxidant rosmarinic acid. In addition, the material isolated by the Lenoble, et al. method contains too much flavor and color to be suitable in certain applications.

U.S. Pat. No. 4,354,035 to Christ et al. describes a process for the isolation of rosmarinic acid specifically from balmmint (Melissa officianalis). This process involves extracting balmmint with hot water, acidifying the extract, extracting the acidified extract with an organic solvent such as organic ethers, water immiscible alcohols or carboxylic acid esters, removing the organic solvent, and crystallizing the rosmarinic acid from the residue. Christ, et al. provide no information regarding the degree of color and/or odor of the intermediate extract.

It would be desirable to provide natural antioxidants that enhance and/or stabilize the flavors and colors of foods and beverages that do not add unwanted colors or flavors to such compositions and that are soluble in aqueous systems.

### SUMMARY OF THE INVENTION

The present invention provides an improved process for preparing additives comprising naturally occurring antioxidants. The additives comprise water-soluble extracts prepared from plant materials of the Labiatae family. The process produces extracts that are essentially odorless, flavorless, and colorless when used at concentrations between about 5 and 1000 ppm. Further, the extracts of this invention contain much less color than similar extracts prepared from the same plant materials by other methods in the art. That is, the extracts of this invention have absorbances of about 0.239 absorbance units at 400 nm when 0.1 mL of the extract is diluted with 10 mL of water.

More specifically, this invention provides a method of producing an improved water-soluble plant extract containing one or more antioxidant compounds from a plant biomass of the Labiatae family, comprising:

(a) contacting a plant biomass with hot water to form a water-soluble crude extract;

(b) adjusting the pH of the crude extract to a level between about 1.7 to about 3.5 to form an acidified plant extract;

(c) adding a water-immiscible organic solvent to the acidified plant extract;

(d) extracting the antioxidant compounds into the organic solvent; and

(e) isolating the organic phase to provide the improved water-soluble plant extract, wherein much of the remaining compounds responsible for the taste, odor and color of the extract remain in the aqueous phase.

The extract can be processed further to remove remaining trace amounts of compounds responsible for the taste, odor, and/or color. This is accomplished by extracting the organic phase isolated in step (e) with a basic aqueous solution to convert the antioxidants to water-soluble salts. The water-soluble salts are extracted into the aqueous phase and much of the residual compounds responsible for taste, odor, and/or color remain in the organic phase. Depending on the intended use of the extract, the basic solution can optionally be passed through a medium such as a reversed-phase column, silica, or a carbon filter to further remove residual compounds responsible for taste, odor, and/or color.

Examples of naturally occurring antioxidants that may be present in the improved extracts of this invention include rosmarinic acid and 3-(3,4-dihydroxyphenyl) lactic acid.

Examples of plant biomasses suitable for purposes of this invention include rosemary, sage, spearmint, balmmint, peppermint, bergamot mint, marjoram, thyme, catnip, oregano, savory, water calamint, penny royal mint, basil, and allspice.

This invention further provides improved water-soluble extracts prepared from plants of the Labiatae family, wherein the extracts are substantially colorless, odorless, and flavorless when used at a concentration between about 5 and 1000 ppm. The improved water-soluble extracts of this invention are suitable for use as additives in foods, beverages, cosmetics, rubber, plastics, paint, etc.

This invention further provides methods for stabilizing and/or enhancing the flavor of foods or beverages comprising adding to the food or beverages a flavor stabilizing and/or enhancing amount of an improved water-soluble extract of this invention.

This invention further provides compositions comprising a food or beverage and a flavor-enhancing and/or stabilizing amount of an improved water-soluble plant extract.

Other features and advantages of the instant invention will become apparent from the following detailed description, and taken in conjunction with the accompanying figures that illustrate by way of example the principles of the instant invention.

### BRIEF DESCRIPTION OF THE FIGURES

The accompanying drawings, which are incorporated herein and form a part of the specification, illustrate preferred embodiments of the present invention and, together with the description, serve to explain the principles of the invention.

In the Figures:

FIG. 1 shows an HPLC chromatogram of an improved water-soluble extract prepared as described in Example 1.

FIG. 2 shows an HPLC chromatogram of a crude rosemary extract.

FIG. 3 shows an HPLC chromatogram of the ethyl acetate extract of Example 2.

FIG. 4 shows an HPLC chromatogram of the aqueous basic extract of Example 2.

FIG. 5 shows an HPLC chromatogram of the final product of Example 2.

FIG. 6 is a graph of the TBARS values versus storage time (days) for turkey samples containing 0 (control), 100, 250 and 500 ppm of an improved water-soluble rosemary extract during storage at 4° C. The vertical bars on the data points are the standard deviations of the means.

FIG. 7 is a bar graph of the hexanal contents in turkey samples containing 0 (control), 100, 250 and 500 ppm of an improved water-soluble rosemary extract during storage for zero or seven days at 4° C. The vertical bars on the columns are the standard deviations of the means.

FIG. 8 is a graph of the Hunter L-values versus storage time (days) for turkey samples treated with 0 (control), 100, 250 and 500 ppm of an improved water-soluble rosemary extract and stored at 4° C. The vertical bars on the data points are the standard deviations of the means.

FIG. 9 is a graph of the Hunter a-values versus storage time (days) for turkey samples treated with 0 (control), 100, 250 and 500 ppm of an improved water-soluble rosemary extract and stored at 4° C. The vertical bars on the data points are the standard deviations of the means.

FIG. 10 is a graph of the Hunter b-values versus storage time (days) for turkey samples treated with 0 (control), 100, 250 and 500 ppm of an improved water-soluble rosemary extract and stored at 4° C. The vertical bars on the data points are the standard deviations of the means.

### DETAILED DESCRIPTION OF THE INVENTION

This invention relates to a process for preparing improved water-soluble extracts from plant materials of the Labiatae family. As used herein, the term “improved” is intended to refer to extracts having less odor and/or flavor and/or color than extracts prepared from the same plant materials by other methods in the art. More specifically, the improved water-soluble extracts of this invention have absorbances of about 0.239 absorbance units at 400 nm when 0.1 mL of the extract is diluted with 10 mL of water, and have substantially no odor or flavor when used at concentrations between about 5 and 1000 ppm.

The improved extracts of this invention are suitable for use as additives in compositions such as foods, beverages, oils, cosmetics, perfumes, plastics, rubber, paints, etc. The term “additives” as used herein refers to an improved water-soluble extract that stabilizes and/or enhances at least the flavor and/or color of any edible or potable composition to which it is added, typically by retarding deterioration, rancidity, discoloration, etc., due to oxidation. Thus, the quality, flavor, and color of a composition containing an improved water-soluble extract of this invention is stabilized, improved, and/or extended relative to a composition without the improved water-soluble extract.

The process of the present invention is different from and an improvement over prior art processes for isolating antioxidants from plants of the Labiatae family such as rosemary and sage. For example, the process described in U.S. Pat. No. 5,908,650 to Lenoble et al. produces an extract having about four times more color that the improved extracts of this invention. That is, the extract produced by the method of Lenoble et al. has an absorbance of about 0.900 absorption units at 400 nm when a 0.1 mL sample of the extract is diluted with 10 mL of water, whereas the extracts of this invention have absorbances of about 0.239 absorption units under the same conditions. Other methods for isolating antioxidants from plant materials, such as those described in U.S. Pat. No. 5,209,870 to Todd, Jr. and U.S. Pat. No. 5,859,293 to Bailey, et al., are selective for the water-insoluble carnosic acid, as compared to the methods of this invention which provide extracts containing water-soluble antioxidant compounds.

The methods of this invention provide extracts that are highly soluble in water. Accordingly, these extracts are very desirable for use as additives to enhance and/or stabilize the flavors and/or colors of aqueous systems, since the extracts of this invention will not precipitate out of such systems. Yet another advantage of the improved water-soluble extracts of this invention is that they are substantially colorless, odorless, and flavorless when added to compositions at concentrations between about 5 and 1000 ppm. Thus, the improved water-soluble extracts of this invention do not alter or modify the color, odor, or taste of a composition to which they are added. The water-soluble extracts of this invention are naturally occurring, and have no known toxic or carcinogenic effects. These water-soluble extracts are obtained relatively easily and inexpensively as described below in detail.

In one embodiment of this invention, one of the antioxidants in the improved water-soluble extracts of this invention is a caffeic acid derivative such as rosmarinic acid. It was discovered that a higher percentage of rosmarinic acid could be isolated by converting the rosmarinic acid to the acidic form. In this form, it is possible to extract a higher percentage of rosmarinic acid into an organic solvent, leaving much of the compounds responsible for the color, odor, and taste of the extract in the aqueous phase. The organic phase is then isolated to provide an improved water-soluble extract containing rosmarinic acid in the amount of about 10 to 50 percent by weight of the improved extract.

In another embodiment, one of the antioxidants in the improved extracts of this invention is 3-(3,4-dihydroxyphenyl) lactic acid.

More specifically, one method of this invention for the production of an improved water-soluble extract comprises:

(a) contacting a plant biomass from the Labiatae family containing antioxidants with hot water to form a crude extract;

(b) adjusting the pH of the crude extract to between about 1.7 to about 3.5 to form an acidified plant extract;

(c) adding a water-immiscible organic solvent to the acidified plant extract;

(d) extracting the antioxidant compounds into the organic phase; and

(e) isolating the organic phase to provide the improved water-soluble extract, wherein much of the remaining compounds responsible for the taste, odor and color of the extract remain in the aqueous phase.

In another embodiment, the organic phase isolated in step (e) is extracted with an aqueous basic solution. In this embodiment, antioxidants (e.g., rosmarinic acid and 3-(3,4-dihydroxyphenyl) lactic acid) present in the extract are converted to their more water-soluble salt forms and are extracted into the aqueous phase, while most of the residual compounds responsible for odor and/or color and/or flavor remain in the organic phase.

As used herein, the terms “plant material” or “biomass” are used interchangeably and are intended to include any plant material from the Labiatae family, including the whole plant or any part of a plant. Thus, the method of this invention is not limited to the particular part of the plant used to prepare the extract. Plants that are members of the Labiatae family include, but are not limited to, members of the genus Acinos, Calamintha, Clinopodium, Glechoma, Hyssopus, Lavandula, Lycopus, Melissa, Mentha, Nepeta, Origanum, Prunella, Rosmarinus, Salvia, Satureja, and Thymus. Specific plants suitable for purposes of this invention include, but are not limited to, rosemary, sage, spearmint, balnmint, peppermint, bergamot mint, oregano majoram, thyme, catnip, savory, water calamint, penny royal mint, basil, and allspice. In one embodiment, the plant material is rosemary. This list is by way of illustration only and is not intended, in any way, to be limitative thereof.

Preferably the plant material is a “Generally Recognized As Safe” (commonly referred to as “GRAS”) material. Extracts from “GRAS” materials are particularly preferred because they do not require FDA approval for use in foods or beverages.

In one embodiment, the biomass or plant starting material to be used in the methods of this invention is used in its natural (i.e., virgin) or fresh form, that is, a biomass that has not been treated or extracted with chemicals, solvents, etc. and/or stored for a long period of time and/or has not been chopped, minced, pulverized, comminuted, etc. In another embodiment, the biomass or plant starting material can be used in its dried or deoiled form and may be in large pieces, such as leaves, or in comminuted form. In yet another embodiment, the biomass or plant starting material can be spent plant material that has been previously extracted with certain solvents or steam distilled.

Prior to the purification methods described herein, the plant biomass is extracted with hot water to form a crude extract. The skilled person in this art will recognize that a variety of extraction methods are available in the literature, such as vat extraction, percolation, countercurrent extraction, etc. A non-limiting example of one such process is described below, using rosemary as an example of a starting plant material. The starting rosemary plant material can be, for example, regular (i.e., virgin) whole, dried, rosemary leaves; whole, dried, de-oiled rosemary leaves; or “spent” rosemary leaves which have been previously extracted or steam distilled.

In one embodiment, the extraction process is accomplished by placing the rosemary biomass in a suitable extraction vessel and covering the biomass with hot water. The temperature in the vessel is maintained at a temperature greater than 80° C., preferably about 90° C., for about 5-8 hours, during which the mixture of biomass and hot water is stirred occasionally. After the extraction is complete, the contents are drained from the vessel and passed through a coarse filter that separates the liquid extract containing the desired compounds from the spent rosemary biomass.

The resulting dark brown liquid extract (i.e., the filtrate) is then pumped to a suitable container whereupon it is agitated while a mineral acid such as phosphoric (H₃PO₄), sulfuric (H₂SO₄) or hydrochloric (HCl) is slowly added to the extract until a pH of about 1.7-3.5 is obtained (preferably between about pH 2.0 and 2.5). The acidification can be done while the extract is still hot, as the extract is cooling, or after it has cooled to room temperature. The resulting acidified aqueous extract contains one or more antioxidants, such as rosmarinic acid or 3-(3,4-dihydroxyphenyl) lactic acid, in their acidic forms.

After the acidified aqueous extract is cooled to room temperature, a water-immiscible organic solvent is added to the acidified aqueous extract in order to separate the water-soluble antioxidants, such as rosmarinic acid or 3-(3,4-dihydroxyphenyl) lactic acid, from compounds responsible for the color, odor and/or taste of the extract. Examples of suitable organic solvents such as organic acetates include, but are not limited to, ethyl acetate, n-propyl acetate, isopropyl acetate, n-butyl acetate, sec-butyl acetate, and t-butyl acetate. Other suitable solvents include ethers such as diethyl ether, and methyl t-butyl ether. After extracting the antioxidants into the organic solvent, the organic phase is separated from the aqueous phase. The organic solvent is removed by evaporation, preferably under reduced pressure to provide a residue. At this point, the residue can be taken up in a solvent suitable for consumption, such as ethanol or water, to provide an improved water-soluble extract that is substantially colorless, odorless, and flavorless when used at concentrations between about 5 and 1000 ppm. The improved water-soluble extract isolated after the above-described steps contains between about 5 and 50 percent rosmarinic acid by weight and is suitable for use as a flavor stabilizer and/or enhancer in many foods and beverages. The volume, solvent, and/or pH of the improved extract can be adjusted as needed prior to adding the improved extract to a composition such as a food or beverage.

Alternatively, for some applications it may be desirable to further treat the improved water-soluble extract prepared as described above to further remove residual color and/or flavor that remains in the organic phase. Accordingly, in another embodiment the organic phase is extracted with a basic aqueous solution to convert antioxidant compounds to their more water-soluble forms. The water-soluble salt forms of the antioxidants are then extracted into the aqueous phase, while much of the compounds responsible for the color, odor, and flavor of the extract remain in the organic phase. Optionally, the organic phase can first be filtered through silica to remove additional color from the extract prior to adding the basic solution. Suitable basic solutions include aqueous solutions of sodium hydroxide, potassium hydroxide, ammonium hydroxide, sodium bicarbonate, and sodium carbonate. Preferably, the addition of the basic aqueous solution is monitored to prevent the solution from becoming overly basic. This typically requires adding the basic aqueous solution until the pH of the aqueous phase is in the range of about 6.5 to about 7.5.

After extracting the antioxidants into the aqueous phase, the aqueous phase is separated from the organic phase and partially concentrated to remove residual organic solvent. The remaining aqueous extract has less color and odor than the product isolated after the organic solvent extraction. In one embodiment, this extract contains between about 5 and 50 percent rosmarinic acid by weight. The improved extracts isolated after the aqueous extraction are suitable for use as a flavor stabilizer in many foods, beverages, oils, etc. The volume, solvent, and/or pH of the improved extract can be adjusted as needed prior to adding the improved extract to a composition. For example, the pH of the extract can be adjusted by the addition of an acid such as phosphoric acid, hydrochloric acid, acetic acid, or citric acid. The volume can be adjusted by the addition of a solvent such as ethanol or water. Ethanol is particularly preferred since it was observed to stabilize the water-soluble extract against microbial growth.

Alternatively, in another embodiment the water-soluble extract obtained after extraction with the basic solution can be loaded onto a column containing a reversed-phase material to further remove residual odor. Reversed-phase materials suitable for purposes of this invention include C18, polystyrene, and divinylbenzene resins.

In yet another embodiment, the improved water-soluble extract obtained after extraction with the basic solution can be passed through a carbon bed, such as a charcoal filter, to remove additional compounds responsible for odor and/or flavor.

The improved water-soluble extracts of this invention have been shown to stabilize the flavor and color of potable and edible compositions without imparting undesired flavor or color to the foods and beverages. The present invention broadly includes the use of improved water-soluble extracts in a wide variety of edible and potable compositions, as well as non-edible compositions. “Compositions” broadly includes both solid foods, liquid beverages, and other edible and potable materials regardless of their specific form, as well as non-edible compositions such as perfumes, cosmetics, plastics, rubber, paint, etc. The extracts can be used as part of an ingredient system, as additives for foods or other products, and can be prepared in a dry, e.g., powdered form or as a water or alcohol-based concentrate or syrup, depending on the end use and the proposed method of addition.

Accordingly, another embodiment of this invention includes a method of stabilizing compositions such as foods or beverages comprising adding a stabilizing amount of an improved water-soluble plant extract of this invention to the composition. This invention further comprises compositions containing a stabilizing amount of an improved water-soluble plant extract of this invention. As used herein, a “stabilizing amount” is an amount of an improved water-soluble extract of this invention that will stabilize the flavor, odor, and/or color of a composition, typically by retarding deterioration, rancidity, discoloration, etc. due to oxidation. As will be understood by those of skill in this art, the concentration of a stabilizing amount of an improved water-soluble plant extract of this invention will generally depend on a combination of factors. Such factors include, for example, the concentration and stability of the food or beverage, the composition and permeability of the packaging material, the contemplated storage temperature, the pH of the final composition, the desired properties of the final composition, and the potency of the improved water-soluble extract. hi general, an improved water-soluble plant extract of this invention is preferably present in the composition in an amount between about 5 and 1000 ppm.

Examples of foods and beverages that can be stabilized according to this invention include, but are not limited to, coffee, salsa, milk, wine, meat, poultry, beverages, oils, and citrus flavored compositions.

For example, it has been found that the flavor and aroma inherent in freshly brewed coffee can be imparted to hot or cold coffee products by the addition of an improved water-soluble extract as described in Example 10. The improved water-soluble extracts of this invention may thus be used to extend the freshness of brewed coffee by adding an improved water-soluble extract of this invention to coffee beans or a coffee product. This may be accomplished in any of a number of ways, including adding an improved water-soluble extract to the coffee beans before, during, or after grinding, adding the extract to coffee grounds just prior to brewing, or adding an improved water-soluble extract to brewed coffee.

In another example, improved water-soluble extracts of this invention were found to stabilize the color, odor, and flavor of salsa and red wine (Examples 12 and 13).

Having now generally described the invention, the same will be more readily understood through reference to the following examples, which are provided by way of illustration, and are not intended to be limiting of the present invention.

### EXAMPLES

Examples 1-9 describe various embodiments of this invention for the preparation of improved water-soluble extracts that are substantially colorless and odorless when used at concentrations between about 5 and 1000 ppm. Examples 10-13 describe the use of the extracts of this invention in stabilizing the flavors of foods and beverages.

### Example 1

A hot water extract of whole rosemary needles (4.0 L) containing 5.13 g/L rosmarinic acid (RA) was adjusted to a pH of 2.5 by the dropwise addition of phosphoric acid while stirring. The acidified rosemary extract was extracted in a large plastic carboy with 2 liters of ethyl acetate with vigorous shaking and allowed to sit overnight. The entire 6 liters of solution were then centrifuged in 600 mL portions. Several portions at a time were transferred to a 2 liter separatory funnel to assist in separating the layers. The orange upper organic layer was decanted after each separation and all of the organic layers were combined. The partition coefficient for the RA(K_{RA}), was determined to be 28.2 for this extraction. The partition coefficient (K_{RA}) was calculated as the ratio between the RA concentrations of the EtOAc and the aqueous fractions. The purity of the RA in the ethyl acetate was assayed at 22.8%.

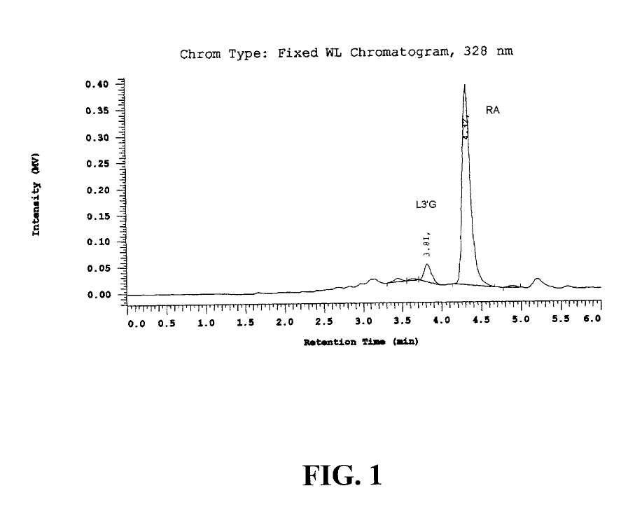

A portion (1.7 L) of the ethyl acetate extract was then extracted three times in a separatory funnel with a total of 390 mL of 1.0M NaHCO₃ which converted the rosmarinic acid to a water-soluble salt and pulled it into the water layer. The aqueous extracts were combined and partially evaporated under reduced pressure to remove the residual ethyl acetate. This gave a colored product with a pH of 6.6 that was stabilized by the addition of 25% ethanol and had a purity of 18.3%. FIG. 1 shows an HPLC chromatogram of the product (RA=rosmarinic acid; L-3′G=luteolin-3′ glucuronide). The HPLC column was a 5 μm bore 4.6×250 mm column loaded with Hypersil ODS. The mobile phase was 34:66 CH₃CN:H₂O with 0.1% trifluoroacetic acid. A 10 μL sample was injected at a flow rate of 1.0 mL/min at 30° C. The wavelength of the detector was 328 nm.

### Example 2

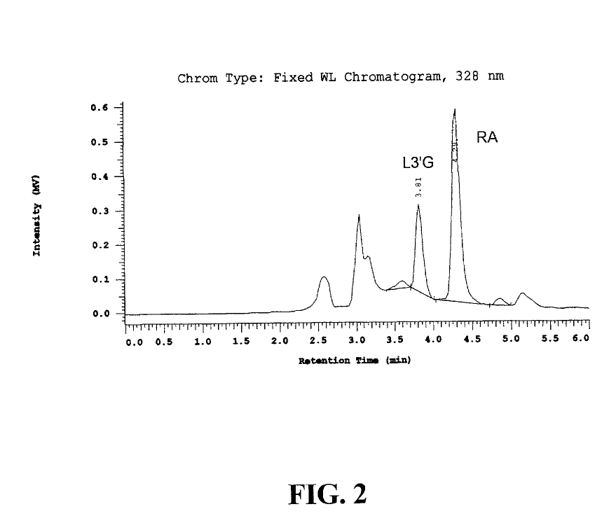

A hot water rosemary extract (16 L) was prepared as described in Example 1. The results of the analysis of the crude extract are summarized in Table 5. FIG. 2 shows an HPLC chromatogram of the crude extract.

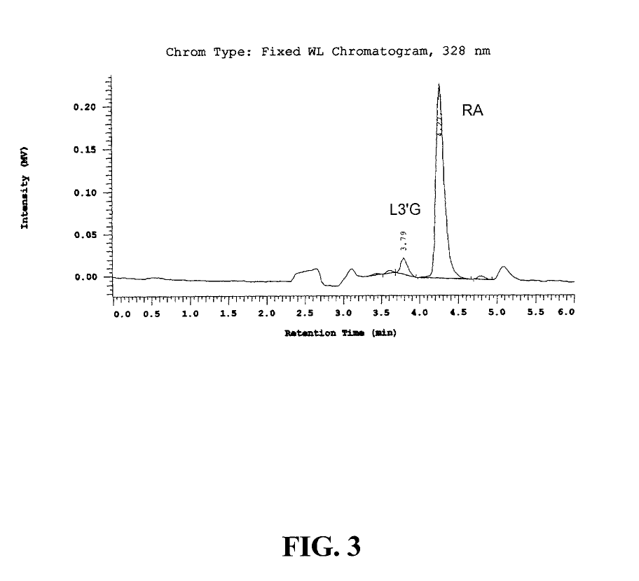

The crude extract was transferred to a 15-gallon tank and acidified to pH 2.5 by adding concentrated phosphoric acid (H₃PO₄) and stirring. To this acidified extract were added 16 L ethyl acetate (EtOAc). The tank was covered, and the mixture was vigorously stirred for one hour. After stirring, the layers were allowed to separate. The organic layer was isolated and found to contain RA at 23.1% purity with a recovery of 96.1%. The partition coefficient was 24.8. FIG. 3 shows the HPLC chromatogram of the ethyl acetate phase.

To the ethyl acetate fraction was added, with stirring, 1.6 L of deionized water. Sodium hydroxide (NaOH) solution was then added to convert the rosmarinic acid to a water-soluble salt. This addition needed to be monitored to minimize the amount of additional solids created and to maintain the RA purity in the final product. In practical terms, this required increasing the pH of the aqueous layer to 7.0±0.5. The lower layer was sampled for pH following each addition of NaOH. A total of 110 mL of a 50% NaOH solution were added. When the pH of the aqueous layer reached 7.5, the tank was covered and the mixture stirred for 45 minutes. The layers were allowed to separate for 30 minutes after the stirring was discontinued, and the aqueous layer was isolated.

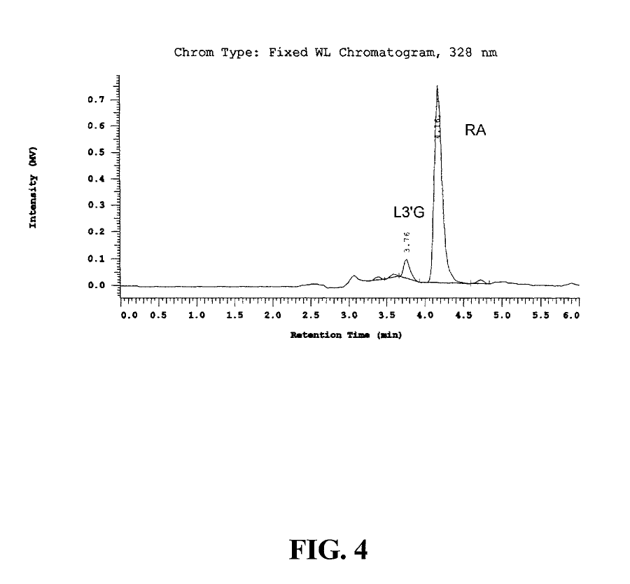

The aqueous layer was evaporated to approximately one-half its starting volume under reduced pressure to remove the residual ethyl acetate and to concentrate the product. The analytical results for the “exhausted” EtOAc fraction and the concentrated aqueous fraction are given below in Table 1. The recovery of RA in the back extraction was 97.7%. The partition coefficient was 42.6. FIG. 4 shows an HPLC chromatogram of the basic aqueous phase containing the water-soluble salt form of the rosmarinic acid.

TABLE 1
Sodium hydroxide back extraction

| | Volume | Solids | | RA |
|---|---|---|---|---|
| Material | (mL) | (g) | RA (g) | Purity |
| EtOAc fraction | 15250 | 474 | 109.6 | 23.1% |
| before extraction | | | | |
| Exhausted EtOAc | 14800 | 29.0 | 2.2 | 7.63% |
| fraction | | | | |
| Concentrated | 1080 | 652^{‡} | 94.2 | 14.5% |
| Product | | | | |

^{‡}The increase in solids was due to the addition of NaOH solution.

Further Deodorization Using C-18 Resin

A glass column packed with Bakerbond C18, 40 micron prep LC packing media in 75% EtOH was used to further deodorize the basic aqueous phase containing the water-soluble salt form of the rosmarinic acid. The column was conditioned by flushing with the following amounts of solvents in order: 4 column volumes (CV's) of 95% EtOH, 8 CV's of 50% EtOH and 10 CV's of deionized water at a flow rate of about 2 mL/min. The concentrated product was loaded onto the column at a flow rate of about 1 mL/min (about 65-85 psi). The treated product was collected in 2 CV fractions. A total of 28 fractions were collected.

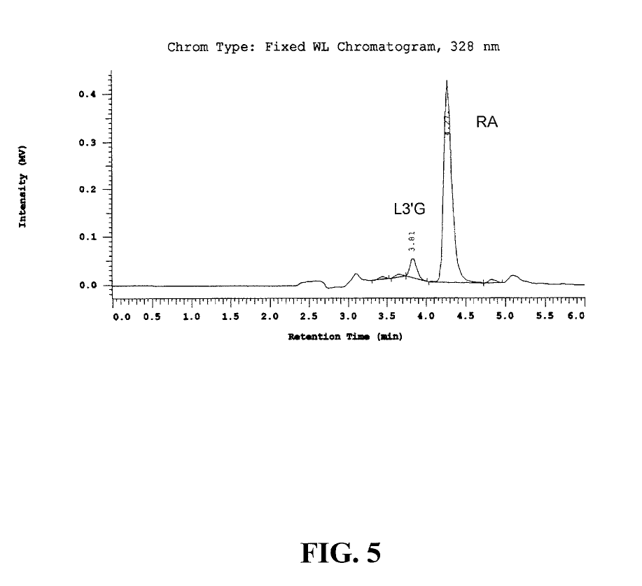

After taste-testing several of the fractions to ensure deodorization and reduction in taste, all of the fractions were combined. The vials were rinsed with an additional 40 mL of deionized water, and 200 mL 95% EtOH were added to create a stabilized final product. The analytical results for this product are summarized in Table 2. FIG. 5 shows an HPLC chromatogram of the final product.

TABLE 2
Analytical results for the product after
deodorization and addition of ethanol

| Analysis | Results | |
|---|---|---|
| Residue | 273.5 | mg/mL |
| Density | 1.06 | g/mL |
| pH (1:10 dilution) | 7.0 | |
| RA by HPLC | 18.3% | RA purity |

### Example 3

A hot water rosemary extract (14.3 L) was transferred to a 15 gallon tank and acidified to pH 2.5 by adding concentrated phosphoric acid (H₃PO₄) while stirring. To this acidified extract were added 14.3 L ethyl acetate (EtOAc). The tank was covered, and the mixture was stirred for one hour. After stirring and separation, the layers were separately removed. Any ethyl acetate present in the aqueous layer was decanted into a large graduated cylinder. The aqueous material was then transferred into a second graduated cylinder. The layers were analyzed for solids and rosmarinic acid (RA) by HPLC. The RA recovery was 95.5%. The measured partition coefficient was 21.4. The data are summarized in Table 3.

TABLE 3
Mass balance results for the ethyl acetate extraction

| | Volume | Solids | | |
|---|---|---|---|---|
| Material | (mL) | (g) | RA (g) | Purity |
| Starting Rosemary | 14300 | 3039 | 112.2 | 3.69% |
| Extract | | | | |
| Aqueous fraction | 14650 | 2846 | 4.8 | 0.17% |
| EtOAc fraction | 13280 | 458 | 102.7 | 22.4% |
| Totals | | 3303^{‡} | 107.5 | |
| % Mass Balance | | 108.7 | 95.8 | |

^{‡}The increase in solids is due to the addition of concentrated H₃PO₄.

The ethyl acetate fraction was returned to the cleaned 15 gallon tank. While stirring, 1.3 L of deionized water were added, followed by 90 mL of 50% NaOH solution (w/w). The pH of the lower layer was 7.3. The mixture was stirred for about 20 minutes and the aqueous layer was removed. The RA recovery was 98.1% for this extraction. The partition coefficient was measured at 51.0. The data are summarized in Table 4.

TABLE 4
Mass balance results after basic back extraction

| | Volume | Solids | | RA |
|---|---|---|---|---|
| Material | (mL) | (g) | RA (g) | Purity |
| EtOAc fraction | 13260 | 457 | 102.5 | 22.4% |
| from the | | | | |
| previous extraction | | | | |
| Exhausted EtOAc | 12600 | 26.0 | 1.9 | 7.48% |
| fraction | | | | |
| Aqueous fraction | 1925 | 452 | 99.0 | 21.9% |
| Totals | | 478^{‡} | 100.9 | |
| % Mass Balance | | 104.6 | 98.4 | |

^{‡}The increase in solids is due to the addition of NaOH solution.

The aqueous layer was evaporated to about 800 mL under reduced pressure and at 45° C. to remove the residual ethyl acetate and to concentrate the product. Additional water was used to rinse the round-bottom flask used for the evaporation resulting in a final volume for the concentrated product of 1220 mL.

The concentrated aqueous layer was passed through a carbon capsule filter (Gelman Part No. 12011) to deodorize it. The resulting product from this treatment had less objectionable aroma and taste (when diluted 1/10000 with water) than the concentrated aqueous layer at the same dilution. The color was not decreased nor was any RA lost in the treatment. Table 5 summarizes the analytical results for the product after concentration and carbon treatment.

TABLE 5
Analytical results from product after
concentration and carbon treatment

| Analysis | Results | RA Purity |
|---|---|---|
| Residue | 361.4 mg/mL | — |
| RA by HPLC | 74.8 mg/mL | 20.7% |

### Example 4

A hot water extract of whole rosemary needles (1.5 L) containing 6.8 g/L rosmarinic acid was adjusted to a pH of 2.5 by the dropwise addition of concentrated sulfuric acid while stirring. This mixture was allowed to sit overnight to settle out calcium sulfate and other insoluble solids and filtered through a 11 cm Buchner funnel using a coarse (VWR #417) filter paper. The filtrate contained 6.0 g/L rosmarinic acid. Then 1 L of the filtrate was placed into a 2 L separatory funnel and extracted three times with 250 mL of ethyl acetate. The ethyl acetate phases were combined and filtered through Whatman #1 filter paper with the aid of vacuum, to remove solids. The ethyl acetate filtrate was returned to the separatory funnel and extracted twice with 150 mL of saturated sodium sulfate solution to remove residual water. The ethyl acetate extract was then dried over 100 g of anhydrous sodium sulfate crystals. The supernate was filtered via gravity into a bottle and the sodium sulfate was washed with a small amount of ethyl acetate. The dried extract (8.54 g rosmarinic acid with a purity of 34.1%) was passed through 175 g of silica gel (60 A, 63-200 um), and the silica gel was washed with 500 mL of dry ethyl acetate. The column product had 8.0 g of rosmarinic acid with a purity of 39.7% and had substantially less color than the initial ethyl acetate extract. The silica column product was extracted with 90 mL of aqueous 1 M NaOH solution. The basic extract had a pH of 6.5 and contained 6.4 g of rosmarinic acid with a purity of 45.4%. Finally, a portion of the basic extract containing about 5 g of RA was acidified to pH 3.0 using phosphoric acid and evaporated in vacuo to about 55 mL to remove residual ethyl acetate. Ethanol (27 mL) was added along with water to a volume of 100 mL in order to adjust the rosmarinic acid concentration to approximately 50 g/L and the alcohol concentration to 25%. The recovery of rosmarinic acid in the various steps is shown in Table 6.

TABLE 6
Recovery of Rosmarinic Acid for each step

| Step | Recovery |
|---|---|
| Acidification and filtration of extract | 89% |
| Ethyl Acetate extraction | 95% |
| Silica column (decolorization) | 94% |
| Aqueous basic back extraction | 91% |
| Overall Recovery | 72% |

### Example 5

A hot water extract of whole rosemary needles was acidified using sulfuric acid to a pH of 2.5 and filtered to remove any insoluble solids that precipitated upon addition of the acid. The rosmarinic acid (RA) content of the filtrate was measured by HPLC and found to be 5.6 mg/mL. Filtered extract (25 mL) and immiscible organic solvent (25 mL) were placed into a 50 mL glass centrifuge tube and shaken vigorously for 2 min. The sample was centrifuged for 5 min., and both the organic layer and the aqueous layer assayed for rosmarinic acid by HPLC and residue by evaporating 5.0 mL in a tared aluminum dish. For color comparison testing, a volume of the organic layer equivalent of 20 mg of rosmarinic acid was placed into a 1 L glass bottle and the organic solvent evaporated, if necessary, using a stream of nitrogen . Water was added to the bottle and the contents mixed well. Samples were then placed in 50 mL Nessler color comparison tubes for color comparison. The results of the series of experiments are summarized in Table 7. The results indicate that organic acetates, such as ethyl, propyl, and butyl acetate (both normal and isomeric forms) are suitable solvents for the liquid/liquid extraction of RA from an acidified hot water extract of rosemary. Ethers such as diethyl ether and methyl t-butyl ether (MTBE) are also suitable for this extraction, however, they are not normally approved for use in food products.

TABLE 7
Comparison of different organic solvents
for extracting acidified rosemary extract

| | RA Concentration¹ | RA Purity | | Color |
|---|---|---|---|---|
| Solvent | (mg/mL) | (%) | Kᵣₐ² | Rank |
| Ethyl Ether | 4.63 | 61.2 | 5 | 1 |
| Isobutyl Acetate | 4.63 | 54.3 | 5 | 2 |
| Butyl Acetate | 5.16 | 52.6 | 13 | 3 |
| MTBE | 5.50 | 43.0 | 55 | 4 |
| Propyl Acetate | 5.37 | 37.3 | 23 | 5 |
| Isopropyl Acetate | 5.43 | 36.6 | 39 | 5 |
| Ethyl Acetate | 5.94 | 23.9 | 30 | 7 |
| n-Butanol | 4.93 | N/D³ | 8 | 8 |

¹Rosmarinic acid concentration in the organic layer
²K_{RA} = partition coefficient of RA (conc. in organic layer/conc. in aqueous layer)
³Not determined

### Example 6

A hot water extract of whole rosemary needles was acidified using sulfuric acid to pH 2.5 and filtered to remove any insoluble solids that precipitated upon addition of the acid. The rosmarinic acid (RA) content of the filtrate was measured by HPLC and found to be 5.6 mg/mL. Filtered extract (200 mL) was transferred into a 500 mL separatory funnel and extracted four times with 80 mL of isopropyl acetate. The combined organic extracts (256 mL) had 950 mg of rosmarinic acid while the spent aqueous layer had 51 mg. The combined isopropyl acetate extract was back extracted with 11 mL of 1 N NaOH and 30 mL of H₂O and then a second time with 30 mL of H₂O. The combined aqueous extracts had a pH of 7.2 and contained a total of 940 mg of rosmarinic acid (99%). The color of a sample containing 20 ppm rosmarinic acid in water was as good or better than a sample that was extracted with ethyl acetate and which was decolorized by passing through silica gel.

### Example 7

The filtered acidified hot water extract of rosemary (250 mL; prepared as described in Example 6) was extracted twice with 80 mL of isobutyl acetate. The mixture needed to be centrifuged in order to break the emulsion that formed. The combined organic extracts (156 mL) had 911 mg (65% of the total) rosmarinic acid while the spent aqueous layer had 459 mg. The combined isobutyl acetate extract was back extracted with 11 mL of 1 N NaOH and 30 mL of H₂O. The aqueous extract was adjusted to a pH of 3.25 by adding phosphoric acid. This aqueous extract contained 806 mg of rosmarinic acid. The color of the product at the 20 ppm rosmarinic acid (RA) level was slightly less than the product produced in Example 6.

### Example 8

A hot water extract of whole rosemary needles was acidified using sulfuric acid to a pH of 2.5 and filtered to remove any insoluble solids that precipitated upon addition of the acid. The rosmarinic acid (RA) content of the filtrate was measured by HPLC and found to be 6.8 mg/mL. Filtered acidified hot water extract (250 mL) was transferred into a 500 mL separatory funnel and extracted twice with 100 mL of n-propyl acetate. The combined organic extracts (215 mL) had 1637 mg of rosmarinic acid (96% of starting amount) while the spent aqueous layer had 15 mg. The combined propyl acetate extract was back extracted twice with 17 mL of 1 N NaOH. The combined aqueous extracts had a pH of 6.2 and contained a total of 1550 mg of rosmarinic acid at a purity of 42.2%. The aqueous extract was adjusted to a pH of 3.2 using phosphoric acid and evaporated under vacuum to about half it original volume to remove the propyl acetate and adjusted to a total volume of 32 mL using 50% ethanol. The color of a sample containing 20 ppm rosmarinic acid in water was slightly less than a sample that was extracted with ethyl acetate and which was decolorized by passing through silica gel.

### Example 9

A hot water extract of rosemary (14.5 L) containing 8.55 g/L rosmarinic acid (RA) was transferred into a 15 gallon plastic tote with conical bottom with outlet and fitted with a pneumatic stirrer. While stirring, sulfuric acid was added until the pH was 2.5. The acidified hot water extract was then emptied into a bucket and filtered under vacuum with the aid of a coarse grade of diatomite to remove some gummy solids. The filtrate was returned to the cleaned plastic tote and extracted with two 4 L portions of n-propyl acetate. The filtrate and propyl acetate were mixed vigorously for about 5 min and then allowed to settle for at least 30 min. Separation of the aqueous and organic layers was quite rapid and there was no significant emulsion formed. After two extractions the spent aqueous layer was analyzed and found to contain less than 5% of the starting rosmarinic acid. Therefore, a third extraction was not performed. A total of 7.55 L of propyl acetate extract was obtained. The results of the acidification, filtration, and propyl acetate extraction are summarized in Table 8.

TABLE 8
Acidification, Filtration, and Propyl Acetate Extraction

| | | Solids | | RA |
|---|---|---|---|---|
| Material | Vol (L) | (g) | RA (g) | Purity |
| Hot Water Extract | 14.5 | 1900 | 124.0 | 6.5% |
| (HWE) | | | | |
| Acidified HWE | 15.0 | 2241 | 120.9 | |
| Filtered acidified | 14.7 | 2293 | 110.5 | |
| HWE | | | | |
| Propyl acetate | 7.55 | 231 | 100.3 | 43.5% |
| extract | | | | |
| Spent acidified HWE | 14.325 | 2074 | 5.3 | |
| Mass Balance | | 100.5% | 95.6% | |

A portion (6.5 L) of the propyl acetate extract was extracted in two portions of 3.0 and 3.5 L in a 6 L tank using 300 mL and 350 mL, respectively, of 1 N NaOH. The basic extracts were combined and some wash water added. The first extract was found to contain 91% of the rosmarinic acid present in the propyl acetate extract. The combined n-propyl acetate layers were extracted a second time with 450 mL of water containing 20 mEq of NaOH. This brought out only 1.1 g of rosmarinic acid and left 7.6 g (8.8%) in the spent propyl acetate layer. The results of the back extraction are summarized in Table 9.

TABLE 9
Back Extraction

| | | Solids | | RA |
|---|---|---|---|---|
| Material | Vol (L) | (g) | RA (g) | Purity |
| Propyl acetate | 6.50 | 198.9 | 86.4 | 43.5% |
| extract | | | | |
| 1^{st} Back | 0.800 | | 78.3 | |
| extraction (BE) | | | | |
| 2^{nd} Back | 0.450 | | 1.1 | |
| extraction (BE) | | | | |
| Combined BE | 1.25 | 148.8 | 77.6 | 52.2% |
| Spent propyl | 6.20 | 22.3 | 7.6 | 34.1% |
| acetate layer | | | | |
| Acidified BE | 1.27 | 190.0 | 74.3 | 39.1% |
| Evaporated BE | 0.760 | 190.0 | 71.3 | 37.5% |
| Final Product | 1.39 | 189.9 | 72.7 | 38.3% |
| Mass Balance | | 83% | 93% | |

The combined basic extracts had a pH of 7.2. About 41 g of phosphoric acid was needed to adjust the pH to 3.25. This lowered the rosmarinic acid purity from 52% to 38%, but the resulting product is believed to be less susceptible to degradation and darkening during evaporation and storage. The 1.27 L of acidified aqueous extract was evaporated under vacuum and at 50° C. or less to 0.76 L. Alcohol (366 mL) and water (264 mL) were added in order to adjust the alcohol content to 25% and the rosmarinic acid concentration to about 50 g/L.

### Example 10

Effects of Water-Soluble Extracts on Coffee Quality

The goal of this example was to determine the potential benefits of the improved water-soluble rosemary extracts of this invention on the sensory properties and overall quality of coffee beverages including brewed coffee. The specific objectives of this example were to evaluate the protection of rosemary extracts on flavor loss and overall acceptance of brewed coffee and to determine the optimum level of a water-soluble extract for flavor retention in coffee brew. The improved extract used in this Example was prepared according the method described above in Example 1.

A sensory evaluation was conducted to evaluate the potential beneficial effects of the improved water-soluble rosemary extracts on the quality of coffee brew. The coffee samples containing 0, 100, and 300 ppm of the improved water-soluble rosemary extracts were prepared under the same conditions and held at 68-70° C. for 50-60 minutes until subjected to the panelists. The improved extract was added to the coffee during brewing. Freshly brewed coffee was also prepared under the same conditions and used as a control. A panel of nine trained participants was asked to compare and evaluate paired coffee brew samples to determine if there was any difference in overall intensity and coffee characteristics of the aroma and flavor. The preferred sample in the pair was indicated if a difference was detected. The four sets of samples examined were: 1) freshly made coffee and held coffee brews with 0 ppm improved water-soluble rosemary extract, 2) held coffee brew with 0 ppm improved water-soluble rosemary extract and held coffee brew with 100 ppm improved water-soluble rosemary extract, 3) held coffee brew with 0 ppm improved water-soluble rosemary extract and held coffee brew with 300 ppm improved water-soluble rosemary extract, and 4) freshly brewed coffee with 0 ppm improved water-soluble rosemary extract and held coffee brew with 300 ppm improved water-soluble rosemary extract. The following is a summary of the results:

Set 1 —Fresh vs. Held Without Improved Extract

(a) Aroma: all panelists were able to establish that there is a difference and that the fresh sample had a more intense coffee aroma.

(b) Flavor: all were able to establish that there is a difference and that the fresh sample had a more intense coffee flavor.

Set 2 —Held With No Improved Extract vs. Held with 100 ppm Improved Extract

(a) Aroma: 7 out of 9 could not detect a difference in the aroma, while the other two were split as to whether one sample or the other had a more intense coffee aroma.

(b) Flavor: all were able to establish that there is a difference in the flavor between the two samples, while 6 out of 9 chose the sample that contained the 100 ppm of antioxidant as having a more intense coffee flavor.

Set 3 —Held With No Improved Extract vs. Held With 300 ppm Improved Extracts

(a) Aroma: 7 out of 9 could detect a difference in the aroma, with 5 of the panelists establishing a difference in the two samples choosing the 300 ppm sample as having a more intense coffee aroma.

(b) Flavor: all were able to establish that there is a difference in the flavor between the two samples, while 6 out of 9 chose the sample that contained the 300 ppm of improved water-soluble rosemary extract as having a more intense coffee flavor.

Set 4 —Fresh vs. Held With 300 ppm Improved Extract

(a) Aroma: 7 out of 9 could detect a difference in the aroma, with all of the panelists that could establish a difference in the two samples choosing the fresh sample as having a more intense coffee aroma.

(b) Flavor: all were able to establish that there is a difference in the flavor between the two samples, while 8 out of 9 chose the fresh sample as having a more intense coffee flavor.

The above results demonstrate that: 1) freshly made coffee had stronger coffee aroma and flavor as compared to held coffee samples containing 0 and 300 ppm improved water-soluble rosemary extract; 2) brewed coffee containing improved water-soluble rosemary extract at levels of 100 and 300 ppm levels had stronger coffee flavor as compared to the held coffee containing no improved water-soluble rosemary extract; and 3) coffee brew containing 300 ppm improved water-soluble rosemary extract had stronger coffee aroma as compared to 0 ppm coffee held for the same time period, but 100 ppm did not.

These tests confirm that the improved water-soluble rosemary extract of this invention has protection of coffee aroma and flavor. Levels of about 100 ppm are recommended for commercial applications.

### Example 11

Improved Water-Soluble Rosemary Extracts as Inhibitors of Lipid Oxidation and Color Change in Cooked Turkey Products During Refrigerated Storage

Many efforts have been devoted to improve quality and stability of precooked meat products because consumer demand for more convenience food has been increasing rapidly (Gütntensperger and Escher, J. Food Sci., 59(4):689-692 (1994)). Flavor and color are two critical quality criteria of meat products that affect consumer acceptance and shelf-life of the products. Lipid peroxidation leads to rapid development of rancid and stale flavors and is considered as one of the primary mechanisms of quality deterioration in precooked meat products (Acton et al., Poultry Sci., 65(6):1124-1128 (1986); Kanner, Meat Sci., 36(1 and 2):169-189 (1994); Demos and Mandigo, Meat Sci., 42(4):415-429 (1996); Güntensperger, et al., J. Food Sci., 63(6):955-957 (1998)). Rate and degree of lipid oxidation are affected by meat composition, fatty acid content, processing conditions and the presence of chemical additives in the meat products. Hydroperoxides formed during lipid peroxidation undergo decomposition or further oxidation followed by decomposition to form secondary reaction products. These secondary products include volatile aldehydes, ketones, acids, alcohols, and hydrocarbon compounds. Aldehydes, including hexanal, are major contributors to rancid and stale flavors in precooked meat products (Britt, et al., J. Agric. Food Chem., 46(12):4891-4897 (1998)).

Volatile carbonyl compounds, including hexanal, can be quantified by GC and GC/MS analysis and used as an indicator of lipid oxidation (Larick and Turner, J. Food Sci. 54(3):649-654 (1990)). Suppression of lipid oxidation is a major way to improve quality and stability of precooked meat products.

The addition of nitrite, phosphates, citric acid, phytic acid and EDTA have been reported to inhibit lipid oxidation and to protect color in meat products (Gray and Pearson, In: Advances in Food Research, London: Academic Press. (Chichester, Mrak, and Schweigert, eds.), pp. 1-86 (1984); Empson, et al., J. Food Sci., 56(2):560-563 (1991); Güntensperger, et al., (1998), supra). Phenolic antioxidants, such as butylated hydroxytoluene (BHT), butylated hydroxyanisole (BHA), tertiary-butylated hydroxyquinone (TBHQ) and propyl gallate also have been reported to inhibit lipid oxidation and color change in meat products (St. Angelo, et al., J. Food Sci., 55(6): 1501 (1990); Güntensperger, et al., (1998), supra).

Recently, the interest in natural antioxidants has increased because of questions about the long-term safety and negative consumer perception of synthetic antioxidants. Some natural antioxidants, including soy protein isolates, cherry tissue and rosemary extracts, were reported to be effective in meat products against lipid oxidation and color change. The antioxidant effects of rosemary extract and its major components have been observed in ground pork products (Gu\ddot{n}tensperger, et al., (1998), supra; Chen, et al., J. Food Sci., 64(1):16-19 (1999)) in several food systems (Offord, et al., Amer. Oil Chem. Soc. Press, pp. 88-96 (1997)), bulk oils and oil-in-water emulsions (Huang, et al., J. Agric. Food Chem., 44(10): 951-6 (1996); Frankel, et al., Lipids, 24(11):976-981 (1996)). However, water-soluble rosemary extracts have not been evaluated for their effects to prevent oxidation of poultry products and improve the quality and stability of poultry products.

Water-soluble rosemary extracts were evaluated for their inhibitory effects on lipid oxidation and color change in cooked turkey products during storage. Changes were measured in thiobarbituric acid-reactive substances, hexanal production and color of the cooked turkey samples containing 0, 100, 250 and 500 ppm water-soluble rosemary extracts, at storage days 0, 1, 2, 3, 5, 7, 10 and 13.

Materials

Fresh turkey breast (additive-free) was purchased from Longmont Foods (Longmont, Colo.). The improved water-soluble rosemary extracts were prepared as described above. Tetraethoxypropane (TEP) and 2-thiobarbituric acid (TBA) were purchased from Sigma-Aldrich (St. Louis, Mo.). Food-grade salt was obtained from a local grocery store and Brifisol 85 Instant, an alkaline phosphate, was donated by BK Ladenburg Corp. (Simi Valley, Calif.). All other chemicals and solvents were commercially highest grade and used without further purification.

Sample Preparation

Simulated commercial turkey rolls were manufactured according to the following weight-based formula: turkey meat (89.2%), salt (1.5%), alkaline phosphate (0.3%), and water and rosemary extracts (9.0%). Fresh turkey breast was ground through a 1.27-cm plate followed by a 0.3-cm plate using a Hobart grinder (Model 4146; Hobart Mfg. Co., Troy, Ohio). All ingredients from each treatment were blended into freshly ground turkey meat to obtain a total weight of 1000 g for each batch. The resulting material was stuffed into a polyurethane vacuum bag and vacuum-sealed using a Multivac sealer (Model C400, Sepp Haggenmuller GmbH & Co., Wolfertschwenden, Germany). After vacuum-packaging, batches were hand-pressed to form rolls and cooked to an internal temperature of 77° C. in a circulating water cooker, then immediately chilled in an ice bath and kept at 2° C. The casing was removed 24 h after cooking. Rolls were sliced to 0.5 cm thickness. Two slices, total about 50 g, were placed in a single layer on polystyrene trays and wrapped with an oxygen-permeable PVC stretch overwrap and covered by aluminum foil, then kept at 4° C. until analysis. Turkey samples were taken at day 0, 1, 2, 3, 5, 7, 10 and 13, and analyzed for lipid oxidation, hexanal production and color change. Triplicate batches were prepared for each treatment.

Statistical Analysis

Analysis of variance (ANOVA) was used to determine the effects of water-soluble rosemary extracts on lipid oxidation and color stability in cooked turkey samples during 13 days of storage, followed by Tukey's multiple range test (SPSS for Windows, Version Rel. 10.0.5., 1999, SPSS Inc., Chicago, Ill.). Mean values and standard deviations were reported. Significance was defined at P<0.05.

Thiobarbituric Acid (TBA) Test

Thiobarbituric acid-reactive substances (TBARS) were determined using a spectrophotometric method according to the procedure described by Tarladgis and others (1964). Briefly, 10 g of meat was homogenized with 50 mL of deionized distilled water using a Polytron homogenizer (Model PT 3100; Brinkman Instruments, Inc., Westbury, N.Y.). The homogenate was filtered through No. 5 Whatman paper. The clear filtrate (1 mL) was mixed with 1 mL TBA reagent, containing 0.02 M TBA in 90% glacial acetic acid. The mixture was incubated in a boiling water bath for 30 min, cooled to ambient temperature and measured for absorbance at 532 nm. The absorbance was converted to TBARS value using 1,1,3,3-tetraethoxypropane to prepare a standard curve. Duplicate 10-g samples were analyzed for each batch.

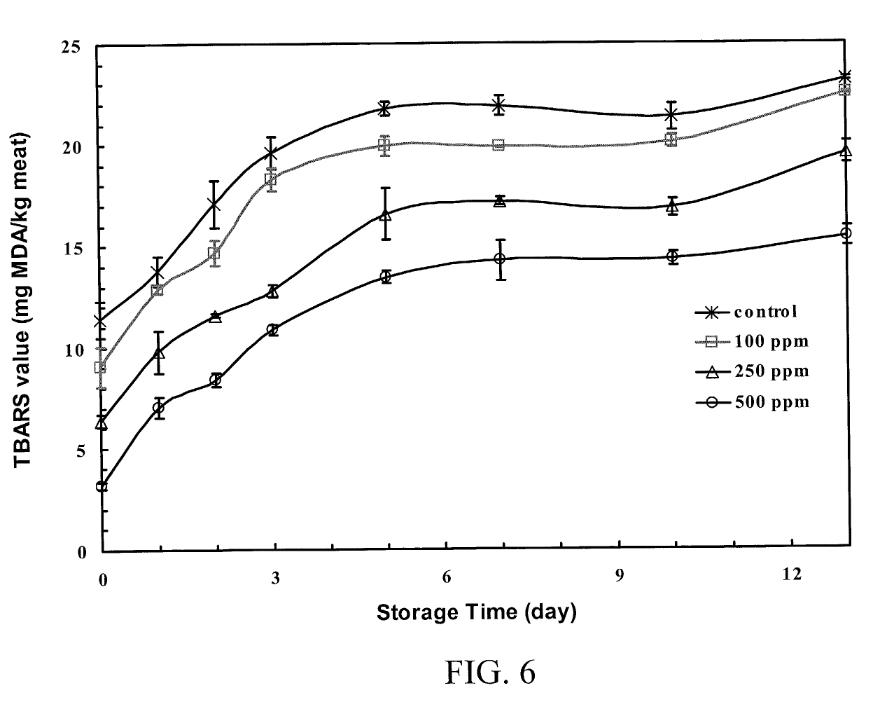

The thiobarbituric acid (TBA) test has been widely used to measure lipid oxidation in meat and meat products (Ahn, J., J. Food Sci., 65(2):270-275 (2000)). Values of TBARS of turkey samples containing different levels of water-soluble rosemary extracts were determined and compared as shown in FIG. 6. TBARS formation was storage time-dependent at 4° C. (FIG. 6). The improved water-soluble rosemary extracts of this invention significantly decreased TBARS formation at all storage times at levels of 250 and 500 ppm, but not at 100 ppm (P<0.05). The higher level of rosemary extract was more effective in preventing lipid oxidation in cooked turkey meat at all storage times (FIG. 6). At day 0 storage, improved water-soluble rosemary extract levels of 250 and 500 ppm reduced the TBARS values of cooked turkey samples from 12.17±0.75 ppm, the TBARS value of the control sample, to 6.80±0.32 ppm and 3.40±0.20 ppm, respectively. After 13 days of storage, the TBARS values of 250 and 500 ppm improved water-soluble rosemary extract treatments were 20.90±0.59 ppm and 16.49±0.51 ppm, respectively, while the control sample had a TBARS value of 24.79±0.11 ppm. The inhibitory effects of the improved water-soluble rosemary extracts of this invention on lipid peroxidation in cooked turkey products might be due to free radical scavenging and transition metal chelating activities of the improved water-soluble rosemary extract components (Huang, et al., J. Agric. Food Chem., 44(10): 951-956 (1996)).

Hexanal Production

Levels of hexanal were analyzed using GC and GC/MS methods following a combined distillation-extraction sampling procedure (Frankel, et al., Lipids, 24(11):976-981 (1989); Larick and Turner, J. Food Sci. 54(3):649-654 (1990)). Meat (35 g) was homogenized with 60 mL of deionized distilled water. The homogenate was transferred into a 500-mL flask with an additional 150 mL water, and distilled at the highest rate to obtain 150 mL of distillate. The distillates were extracted 3 times with 50 mL dichloromethane each. Three extracts were combined, dried with anhydrous sodium sulfate, and concentrated to 1 mL for GC analysis.

GC analysis was carried out with a HP 5890 gas chromatograph equipped with an autosampler, ChemStation™, and FID detector (Hewlett-Packard Co., Avondale, Pa.). A fused silica capillary DB-5 column (30 m×0.25 mm i.d. with 0.25 μm film thickness; J & W Scientific, Folsom, Calif.) was used with helium as the carrier gas. Oven temperature was kept at 60° C. for 2 min and then programmed to 250° C. at a rate of 3° C./min and held for 15 min. Hexanal was identified by GC/MS and by comparing the retention time with a commercial standard obtained from Sigmna Chemical Co. (St. Louis, Mo.).

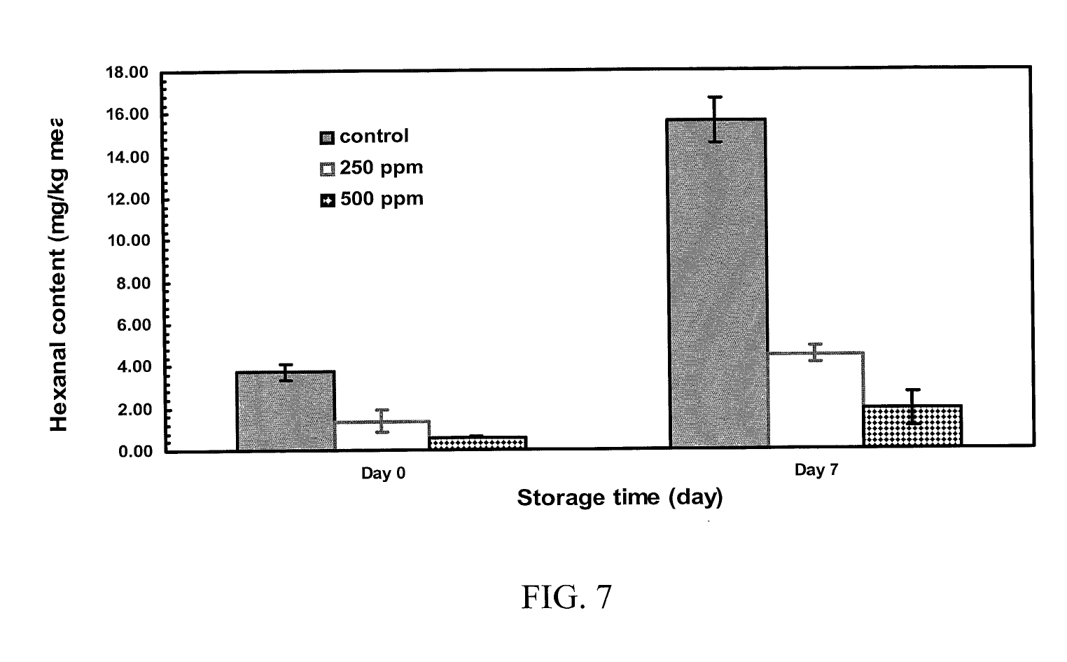

Hexanal, a product from lipid oxidation, was measured as an indicator of changes in volatiles from cooked turkey during storage. Hexanal is a breakdown product from the 13-hydroperoxide of fatty acids, including linoleic, linolenic, and arachidonic acids (Wu and Brewer, J. Food Sci., 59(4):702-706 (1994)). Hexanal contents in turkey treated with 250 and 500 ppm of the improved water-soluble rosemary extract were measured on storage day 0 and 7, and compared with hexanal contents in the control samples. Agreeing with the results from TBA tests, the improved water-soluble rosemary extract reduced hexanal contents on both test days, with 500 ppm being more effective than 250 ppm (FIG. 7). Hexanal levels in samples treated with 250 ppm of the improved water-soluble rosemary extract were 37% and 25% of that in control samples on day 0 and day 7, respectively. With 500 ppm improved water-soluble rosemary extract, hexanal contents decreased to 16% and 11% of that in control samples on day 0 and day 7, respectively.

Surface Color

Surface color of poultry products was measured in duplicate for each sample with a HunterLab Labscan spectrophotometer (Hunter Associates Labs., Reston, Va.). Hunter L-(lightness), a-(redness), and b-(yellowness) values were obtained using a setting of D65 (daylight, 65-degree light angle) (Smith and Alvarez, J. Food Sci., 53(1):46-48 (1988)). An average value from 2 random locations on the top of each sample was used for statistical analysis.

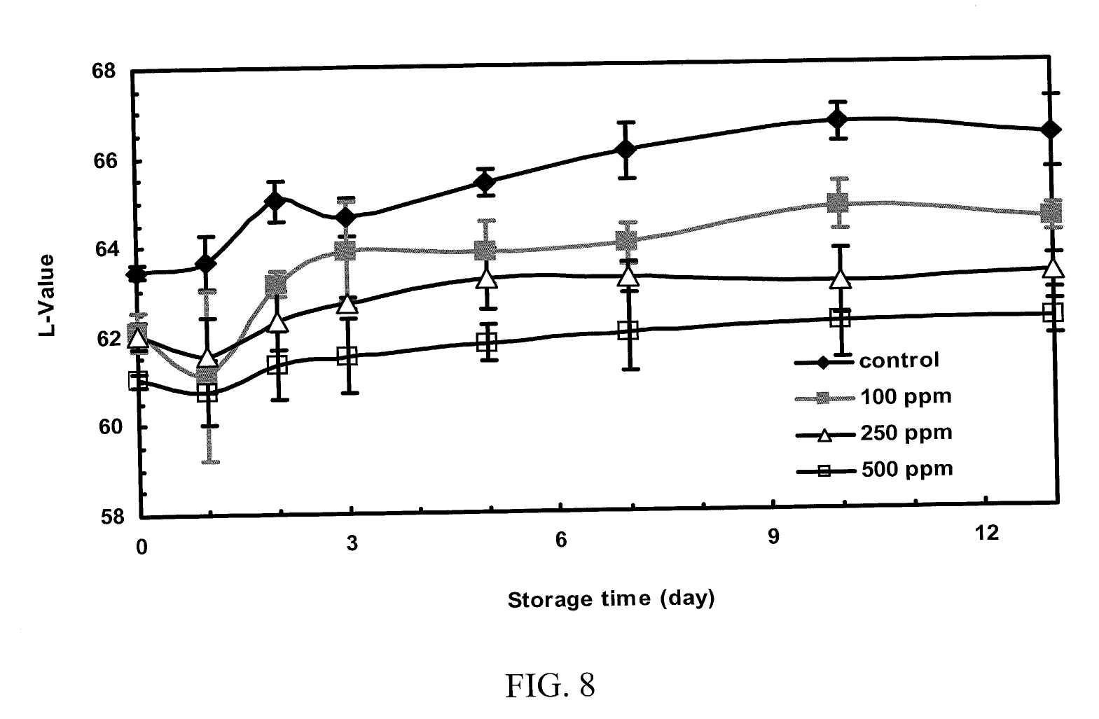

The improved water-soluble rosemary extracts significantly decreased Hunter L-values (lightness) of cooked turkey meat at all tested storage days (FIG. 8). Higher levels of improved water-soluble rosemary extract were correlated to darker color of the products. This may be explained by the brown color and the reducing power of the improved water-soluble rosemary extract. Lee, et al., Meat Sci., 51(3):245-253 (1999) indicated that antioxidants inhibit metmyoglobin formation to prevent color changes in meat products. At day 0 of storage, L-values significantly differed among antioxidant treatments, except with treatments of 100 and 250 ppm of the improved water-soluble rosemary extract. Levels of 250 and 500 ppm of the improved water-soluble rosemary extract resulted in the reduced L-values of 62.04±0.30 and 61.03±0.72, respectively, while the L-value of the control sample was 63.47±0.14 at day 0 storage. At 13 days storage, L-values of 63.27±0.38 and 62.24±0.38 were detected in samples treated with 250 and 500 ppm of the improved water-soluble rosemary extract, respectively, while the L-value of the control was 66.38±0.79. Less of a change in the L-values also was observed in meat samples treated with the improved water-soluble rosemary extract.

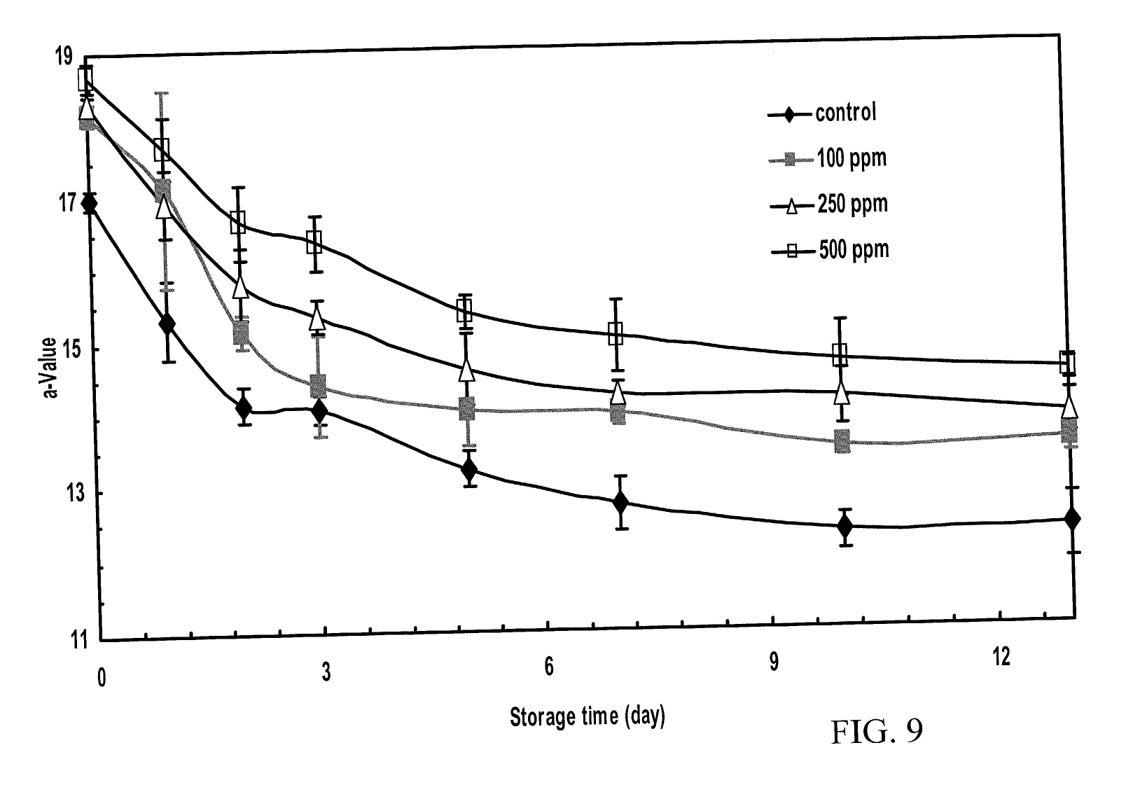

Turkey samples containing the improved water-soluble rosemary extract had higher Hunter a-values than that of the control. The improved water-soluble rosemary extracts delayed the decrease of a-values of cooked turkey significantly at all storage days tested (FIG. 9). Higher levels of the improved water-soluble rosemary extract were associated with greater a-values of the samples. At storage day 0, significant differences of a-values were observed among all treatment groups, except with groups treated with between 100 and 250 ppm of the improved water-soluble rosemary extract.

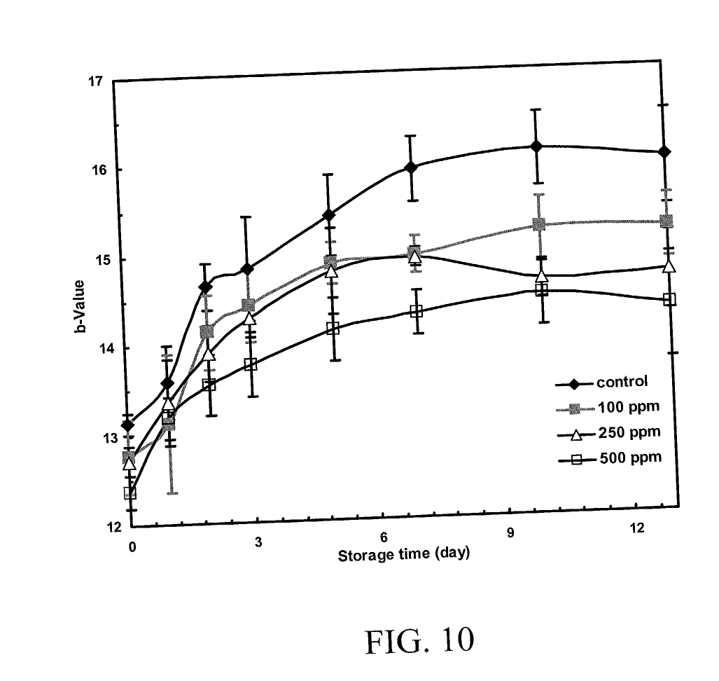

Treatment with 500 ppm of the improved water-soluble rosemary extract significantly delayed increase of Hunter b-values at all storage days (FIG. 10). Higher levels of the improved water-soluble rosemary extract were correlated with lower b-values at most test days, although the data were not very consistent.

In conclusion, the improved water-soluble rosemary extract inhibits lipid oxidation and color change in cooked poultry products during refrigerated storage and, consequently, can improve product quality and shelf life. These natural antioxidants have better consumer acceptance and can be used to replace synthetic antioxidants in commercial meat products.

### Example 12

Evaluation of Improved Water-Soluble Rosemary Extracts on Salsa

Improved water-soluble rosemary extracts were evaluated for their inhibitory effects on lipid oxidation and color change in salsa. Pace All Natural Picante Sauce was purchased in bulk. ColorEnhance-R® (Lot 2340-41-14), referred to as “C,” and StabilEnhance-WRS® (Lot 2344-085-09), referred to as “S,” were evaluated.

C and S were added in increasing amounts (0, 5, 10, 20, 40 and 80 ppm) before heat processing the salsa at 180° F. for 20 minutes. The products were packed while still hot into glass canning jars. The products were then exposed to constant light at 110° F. for four weeks (equivalent to four months at room temperature). Five units of each of the products were processed, stored, and evaluated. Starting at week zero (the same day as processing) and each following week, one set of samples was evaluated for color (Hunter Lab Color Difference meter for L, a and b values).

To evaluate flavor, a trained panel of ten individuals ranging in age from 20-56, (six females and four males) was used. Coded samples were randomly presented under dim lights to negate any possible color differences. The panel was individually presented with a coded control sample and another sample representing one of the variables (i.e., S or C at 0, 5, 10, 20, 40 or 80 ppm). The panel was asked if the two samples smelled and tasted different. Their comments relative to specific aroma and flavor notes were encouraged. The results are summarized in Tables 10 through 13.

Table 10, which provides the Hunter-L color values for Lots S and C at 0, 5, 10, 20, 40 and 80 ppm, shows that the salsa darkened until 20 or more ppm of the water-soluble extract (either lot S or C) was incorporated, and that the salsa maintained color at or above 20 ppm with both Lot S and C. Table 11, which provides the Hunter-a values for Lots S and C at 0, 5, 10, 20, 40 and 80 ppm, shows that the red color remained constant at or above 20 ppm for both lots. Table 12, which provides the Hunter-b color values for Lots S and C at 0, 5, 10, 20, 40 and 80 ppm, shows that the salsa maintains a yellow color at or above 20 ppm for both Lot S and C. Table 13, which provides the results of the flavor evaluations, shows that for both Lots S and C concentrations at or above 20 ppm maintained sensory properties. This study therefore demonstrates that the improved water-soluble rosemary extracts of this invention are effective in maintaining color and flavor in salsa.

TABLE 10
Salsa - Hunter-L Values

| | WEEK | | | | |
|---|---|---|---|---|---|
| CONC. | 0 | 1 | 2 | 3 | 4 |
| S0 | 66.4 | 66.6 | 66.9 | 69.1 | 69.3 |
| S5 | 66.3 | 66.4 | 66.7 | 66.9 | 67.1 |
| S10 | 66.4 | 66.5 | 66.6 | 66.7 | 66.9 |
| S20 | 66.0 | 66.1 | 66.3 | 66.5 | 66.7 |
| S40 | 65.6 | 65.7 | 65.5 | 66.6 | 66.6 |
| S80 | 65.4 | 65.5 | 65.4 | 65.5 | 65.5 |
| C0 | 66.5 | 66.7 | 66.9 | 69.4 | 69.5 |
| C5 | 66.5 | 66.6 | 66.8 | 66.9 | 67.0 |
| C10 | 66.3 | 66.4 | 66.6 | 66.8 | 66.9 |
| C20 | 66.2 | 66.2 | 66.4 | 66.5 | 66.5 |
| C40 | 65.9 | 65.9 | 65.9 | 66.0 | 66.1 |
| C80 | 65.6 | 65.7 | 65.7 | 65.8 | 65.8 |

TABLE 11
Salsa - Hunter-a values

| | WEEK | | | | |
|---|---|---|---|---|---|
| CONC. | 0 | 1 | 2 | 3 | 4 |
| S0 | +14.5 | +14.3 | +14.0 | +13.8 | +13.5 |
| S5 | +14.7 | +14.5 | +14.3 | +14.1 | +13.7 |
| S10 | +14.8 | +14.5 | +14.4 | +14.3 | +14.0 |
| S20 | +15.2 | +15.1 | +15.1 | +15.0 | +14.8 |
| S40 | +15.3 | +15.2 | +15.2 | +15.2 | +15.1 |
| S80 | +15.5 | +15.4 | +15.4 | +15.4 | +15.3 |
| C0 | +14.6 | +14.4 | +14.1 | +13.9 | +13.6 |
| C5 | +14.6 | +14.4 | +14.1 | +13.9 | +13.6 |
| C10 | +14.8 | +14.7 | +14.5 | +14.4 | +14.2 |
| C20 | +14.9 | +14.8 | +14.7 | +14.7 | +14.6 |
| C40 | +15.2 | +15.1 | +15.1 | +15.0 | +15.0 |
| C80 | +15.4 | +15.4 | +15.3 | +15.3 | +15.2 |

TABLE 12
Salsa - Hunter-b Values

| | WEEK | | | | |
|---|---|---|---|---|---|
| CONC. | 0 | 1 | 2 | 3 | 4 |
| S0 | +4.2 | +4.1 | +4.0 | +3.8 | +3.6 |
| S5 | +4.1 | +4.0 | +4.0 | +3.7 | +3.5 |
| S10 | +4.1 | +4.1 | +4.0 | +3.8 | +3.8 |
| S20 | +4.0 | +4.0 | +4.0 | +4.0 | +4.0 |
| S40 | +4.0 | +4.0 | +4.0 | +4.0 | +4.0 |
| S80 | +4.0 | +4.0 | +4.0 | +4.0 | +4.0 |
| C0 | +4.3 | +4.1 | +3.9 | +3.9 | +3.7 |
| C5 | +4.2 | +4.1 | +3.9 | +3.9 | +3.7 |
| C10 | +4.2 | +4.1 | +4.0 | +3.9 | +3.8 |
| C20 | +4.1 | +4.1 | +4.0 | +4.0 | +3.9 |
| C40 | +4.1 | +4.1 | +4.1 | +4.1 | +4.0 |
| C80 | +4.1 | +4.1 | +4.1 | +4.1 | +4.1 |

TABLE 13
Salsa - Flavor

| | WEEK | | | | |
|---|---|---|---|---|---|
| CONC. | 0 | 1 | 2 | 3 | 4 |
| S0 | 10 | 10 | 10 | 10 | 10 |
| S5 | 7 | 8 | 8 | 9 | 9 |
| S10 | 5 | 8 | 8 | 9 | 9 |
| S20 | 1 | 3 | 3 | 4 | 4 |
| S40 | 1 | 2 | 2 | 2 | 3 |
| S80 | 0 | 0 | 0 | 1 | 1 |
| C0 | 10 | 10 | 10 | 10 | 10 |
| C5 | 8 | 8 | 8 | 9 | 9 |
| C10 | 6 | 7 | 7 | 8 | 8 |
| C20 | 2 | 2 | 3 | 3 | 4 |
| C40 | 1 | 2 | 2 | 2 | 2 |
| C80 | 0 | 0 | 0 | 0 | 1 |

### Example 13

Evaluation of Improved Water-Soluble Rosemary Extracts on Red Wine

Commercial Carlo Rossi Burgundy red wine was purchased in bulk. Twelve-ounce clear glass canning jars were used for containers. ColorEnhance-R® (Lot 2340-41-14), referred to as “C,” and StabilEnhance-WSR® (Lot 2344-085-09), referred to as “S,” were evaluated.

C and S were added to a series of five jars in different amounts (0, 5, 10, 20, 40 and 80 ppm). Red wine (200 mL) was added, and the jars were immediately capped. The jars were exposed to constant light at 110° F. for four weeks (equivalent to four months at room temperature). Starting at week zero (the same day as processing) and each following week, one set of samples was evaluated for color (Hunter Lab Color Difference meter for L, a and b values). To evaluate flavor, a trained panel of ten individuals ranging in age from 20-56, (six females and four males) was used. Coded samples were randomly presented under dim lights to negate any possible color differences. The panel was individually presented with a coded control sample and another sample representing one of the variables (i.e., S or C at 0, 5, 10, 20, 40 or 80 ppm). The panel was asked if the two samples smelled and tasted different. Their comments relative to specific aroma and flavor notes were encouraged. The results are summarized in Tables 14 through 17.

Table 14, which provides the Hunter-L color values for Lots S and C at 0, 5, 10, 20, 40 and 80 ppm, shows that both S and C were effective at concentrations at or above 20 ppm in maintaining overall red wine color. Table 15, which provides the Hunter-a color values for Lots S and C at 0, 5, 10, 20, 40 and 80 ppm, shows that both lots were effective in maintaining the red wine color at or above 20 ppm. Table 16, which provides the Hunter-b color values for Lots S and C at 0, 5, 10, 20, 40 and 80 ppm, shows that both lots were effective in maintaining the blue color portion in red wine. Table 17, which provides the results of the flavor evaluations, shows that for both Lots S and C concentrations at or above 20 ppm maintained sensory properties. This study therefore demonstrates that the improved water-soluble rosemary extracts of this invention are effective in maintaining color and flavor in red wine.

TABLE 14
Red Wine - Hunter-L Values

| | WEEK | | | | |
|---|---|---|---|---|---|
| CONC. | 0 | 1 | 2 | 3 | 4 |
| S0 | 53.5 | 53.3 | 53.0 | 53.0 | 52.8 |
| S5 | 53.2 | 53.2 | 53.2 | 53.1 | 53.0 |
| S10 | 53.1 | 53.1 | 53.0 | 53.0 | 52.9 |
| S20 | 53.3 | 53.2 | 53.2 | 53.2 | 53.1 |
| S40 | 53.2 | 53.2 | 53.1 | 53.1 | 53.1 |
| S80 | 53.3 | 53.2 | 53.2 | 53.2 | 53.2 |
| C0 | 53.1 | 53.0 | 52.9 | 52.9 | 52.7 |
| C5 | 53.2 | 53.1 | 53.0 | 53.0 | 52.8 |
| C10 | 53.3 | 53.2 | 53.2 | 53.1 | 53.0 |
| C20 | 53.3 | 53.3 | 53.2 | 53.2 | 53.1 |
| C40 | 53.3 | 53.3 | 53.2 | 53.0 | 53.0 |
| C80 | 53.2 | 53.2 | 53.2 | 53.2 | 53.1 |

TABLE 15
Red wine - Hunter-a values

| | WEEK | | | | |
|---|---|---|---|---|---|
| CONC. | 0 | 1 | 2 | 3 | 4 |
| S0 | +14.3 | +14.1 | +14.0 | +13.8 | +13.6 |
| S5 | +14.2 | +14.1 | +14.0 | +13.9 | +13.8 |
| S10 | +14.1 | +14.1 | +14.0 | +13.8 | +13.7 |
| S20 | +14.4 | +14.4 | +14.4 | +14.3 | +14.2 |
| S40 | +14.3 | +14.3 | +14.2 | +14.2 | +14.2 |
| S80 | +14.1 | +14.4 | +14.3 | +14.3 | +14.3 |
| C0 | +14.2 | +14.0 | +14.0 | +13.9 | +13.7 |
| C5 | +14.3 | +14.2 | +14.2 | +14.0 | +13.8 |
| C10 | +14.1 | +14.0 | +14.0 | +13.9 | +13.8 |
| C20 | +14.4 | +14.3 | +14.3 | +14.2 | +14.1 |
| C40 | +14.3 | +14.3 | +14.3 | +14.2 | +14.1 |
| C80 | +14.2 | +14.2 | +14.2 | +14.1 | +14.1 |

TABLE 16
Red wine - Hunter-b values

| | WEEK | | | | |
|---|---|---|---|---|---|
| CONC. | 0 | 1 | 2 | 3 | 4 |
| S0 | −4.4 | −4.2 | −4.2 | −4.1 | −3.9 |
| S5 | −4.3 | −4.2 | −4.1 | −4.0 | −4.0 |
| S10 | −4.4 | −4.3 | −4.2 | −4.2 | −4.1 |
| S20 | −4.3 | −4.3 | −4.3 | −4.2 | −4.2 |
| S40 | −4.3 | −4.3 | −4.3 | −4.3 | −4.2 |
| S80 | −4.4 | −4.4 | −4.4 | −4.3 | −4.3 |
| C0 | −4.3 | −4.2 | −4.1 | −4.0 | −3.7 |
| C5 | −4.3 | −4.2 | −4.0 | −4.0 | −3.9 |
| C10 | −4.4 | −4.3 | −4.3 | −4.1 | −4.0 |
| C20 | −4.4 | −4.3 | −4.3 | −4.2 | −4.2 |
| C40 | −4.3 | −4.3 | −4.3 | −4.3 | −4.2 |
| C80 | −4.3 | −4.3 | −4.3 | −4.3 | −4.3 |

TABLE 17
Red Wine - Flavor

| | WEEK | | | | |
|---|---|---|---|---|---|
| CONC. | 0 | 1 | 2 | 3 | 4 |
| S0 | 10 | 10 | 10 | 10 | 10 |
| S5 | 10 | 10 | 10 | 10 | 10 |
| S10 | 8 | 10 | 10 | 10 | 10 |
| S20 | 2 | 3 | 3 | 3 | 3 |
| S40 | 1 | 2 | 2 | 2 | 2 |
| S80 | 1 | 1 | 1 | 2 | 2 |
| C0 | 10 | 10 | 10 | 10 | 10 |
| C5 | 10 | 10 | 10 | 10 | 10 |
| C10 | 9 | 9 | 10 | 10 | 10 |
| C20 | 3 | 3 | 2 | 2 | 2 |
| C40 | 1 | 1 | 1 | 2 | 2 |
| C80 | 1 | 1 | 1 | 2 | 2 |

The invention may be embodied in other specific forms without departing from its essential characteristics. The described embodiments are to be considered in all respects only as illustrative and not as restrictive. Indeed, those skilled in the art can readily envision and produce further embodiments, based on the teachings herein, without undue experimentation. The scope of the invention is, therefore, indicated by the appended claims rather than by the foregoing description. All changes that come within the meaning and range of the equivalence of the claims are to be embraced within their scope.

The terms “comprises” and “comprising” when used in this specification is taken to specify the presence of stated features, integers, steps or components but does not preclude the presence or addition of one or more other features, integers, steps, components or groups thereof.

We claim:

1. A method of producing an improved water-soluble plant extract of a plant biomass of the Labiatae family containing one or more antioxidant compounds, wherein said extract is essentially odorless, flavorless and colorless when used at a concentration between about 5 and 1000 ppm and has an absorbance of about 0.239 absorbance units at 400 nm when 0.1 mL of the extract is diluted with 10 mL of water, the method comprising:
(a) contacting said plant biomass with hot water to form a water-soluble crude extract;
(b) adjusting the pH of the crude extract to between about 1.7 and 3.5 to form an acidified plant extract;
(c) adding a water-immiscible organic solvent to said acidified plant extract;
(d) extracting said antioxidant compounds into the organic solvent; and
(e) isolating said organic solvent to provide said improved water-soluble plant extract.

2. The method of claim 1, wherein the pH is adjusted to approximately 1.7 to 3.5 by the addition of an acid selected from the group consisting of phosphoric acid, sulfuric acid, and hydrochloric acid.

3. The method of claim 1, wherein said organic solvent is selected from the group consisting of ethyl acetate, n-propyl acetate, isopropyl acetate, n-butyl acetate, sec-butyl acetate, t-butyl acetate, diethyl ether, and methyl t-butyl ether.

4. The method of claim 1, wherein said plant biomass is from a genus selected from the group consisting of Acinos, Calamintha, Clinopodium, Glechoma, Hyssopus, Lavandula, Lycopus, Melissa, Mentha, Nepeta, Origanum, Prunella, Rosmarinus, Salvia, Satureja, and Thymus.

5. The method of claim 1, wherein said plant biomass is selected from the group consisting of rosemary, sage, spearmint, balmmint, peppermint, bergamot mint, marjoram, thyme, catnip, savory, water calamint, penny royal mint, basil, and allspice.

6. The method of claim 1, wherein said plant biomass is rosemary.

7. The method of claim 1, wherein one of said antioxidant compounds is rosmarinic acid.

8. The method of claim 1, further comprising:
(f) adding a basic aqueous solution to said extract isolated in step (e) in an amount sufficient to extract said water-soluble antioxidants into the aqueous phase, wherein the pH of the extract is between about 6.5 and 7.5.

9. The method of claim 8, wherein said basic aqueous solution is selected from the group consisting of sodium hydroxide, sodium bicarbonate, potassium hydroxide, ammonium hydroxide, and sodium carbonate.

10. The method of claim 8, further comprising:
(g) loading said aqueous phase onto a reversed-phase matrix; and
(h) eluting said water-soluble antioxidants.

11. The method of claim 10, wherein said reversed-phase matrix is selected from the group consisting of C18, polystyrene resin, and divinylbenzene resin.

12. The method of claim 8, further comprising passing said aqueous phase through a carbon filter.

13. The method of claim 8, further comprising filtering said extract of step (e) through silica prior to adding said basic aqueous solution.

14. The method of claim 7, wherein said rosmarinic acid is present in an amount between about 10 and 50 percent by weight of said improved extract.

15. The method of claim 1, wherein said extract contains 3-(3,4-dihydroxyphenyl) lactic acid.

16. A method for the production of an improved water-soluble plant extract from a plant biomass containing rosmarinic acid, wherein said extract is essentially odorless, flavorless and colorless when used at a concentration between about 5 and 1000 ppm and has an absorbance of about 0.239 absorbance units at 400 nm when 0.1 mL of the extract is diluted with 10 mL of water, the method comprising:
(a) contacting said plant biomass with hot water to form a crude extract containing rosmarinic acid;
(b) adjusting the pH of the crude extract to between about 2 and 3 to form an acidic plant extract;
(c) adding to said acidified plant extract an organic solvent selected from the group consisting of ethyl acetate, n-propyl acetate, isopropyl acetate, n-butyl acetate, sec-butyl acetate, t-butyl acetate, diethyl ether, and methyl t-butyl ether;
(d) extracting said rosmarinic acid into said organic phase;
(e) adding a basic aqueous solution to said extract of step (d);
(f) extracting said rosmarinic acid into said aqueous phase; and
(g) passing said aqueous phase of step (f) through a reversed-phase matrix or a carbon filter.

17. The method of claim 16, further comprising passing said organic phase of step (d) though silica prior to step (e).

18. An additive for use in foods and beverages comprising an improved water-soluble plant extract, wherein said extract is prepared from a plant biomass from the Labiatae family containing antioxidant compounds, wherein said extract is essentially odorless, flavorless and colorless when used at a concentration between about 5 and 1000 ppm and has an absorbance of about 0.239 absorbance units at 400 nm when 0.1 mL of the extract is diluted with 10 mL of water.

19. An additive prepared according to the method of claim 1.

20. An additive prepared according to the method of claim 8.

21. An additive prepared according to the method of claim 10.

22. An additive prepared according to the method of claim 12.

23. An additive prepared according to the method of claim 13.

24. An additive prepared according to the method of claim 16.

25. An additive prepared according to the method of claim 17.

26. A method of stabilizing the taste and/or color of a composition without imparting any unsatisfactory color or flavor, comprising adding to said composition a sufficient amount of an improved water-soluble plant extract prepared from a plant biomass from the Labiatae family containing one or more antioxidant compounds, wherein said extract is essentially odorless, flavorless and colorless when used at a concentration between about 5 and 1000 ppm and has an absorbance of about 0.239 absorbance units at 400 nm when 0.1 mL of the extract is diluted with 10 mL of water.

27. A method for producing a coffee product having coffee flavor that resembles freshly brewed coffee, comprising adding to coffee beans before or after grinding said beans or adding to said coffee product an effective flavor stabilizing amount of an improved water-soluble plant extract, wherein said extract is prepared from a plant biomass from the Labiatae family containing one or more antioxidant compounds, said extract being essentially odorless, flavorless and colorless when used at a concentration between about 5 and 1000 ppm and having an absorbance of about 0.239 absorbance units at 400 nm when 0.1 mL of the extract is diluted with 10 mL of water.

28. An edible or potable composition comprising a flavor and/or color stabilizing amount of an improved water-soluble extract prepared from a plant biomass from the Labiatae family containing one or more antioxidant compounds, wherein said extract is essentially odorless, flavorless and colorless when used at a concentration between about 5 and 1000 ppm and has an absorbance of about 0.239 absorbance units at 400 nm when 0.1 mL of the extract is diluted with 10 mL of water.

29. A coffee product comprising brewed coffee and an amount of an improved water-soluble extract prepared from a plant biomass from the Labiatae family containing one or more antioxidant compounds, wherein said extract is present in an amount sufficient to enhance and/or stabilize the flavor of said coffee, said extract being essentially odorless, flavorless and colorless when used at a concentration between about 5 and 1000 ppm and having an absorbance of about 0.239 absorbance units at 400 nm when 0.1 mL of the extract is diluted with 10 mL of water.

30. A method for producing a salsa product having a flavor that resembles fresh salsa, comprising adding to said salsa an effective flavor stabilizing amount of an improved water-soluble plant extract prepared from a plant biomass from the Labiatae family containing one or more antioxidant compounds, said extract being essentially odorless, flavorless and colorless when used at a concentration between about 5 and 1000 ppm and having an absorbance of about 0.239 absorbance units at 400 mn when 0.1 mL of the extract is diluted with 10 niL of water.

31. A salsa product comprising salsa and an improved water-soluble plant extract in an amount sufficient to stabilize the flavor of said salsa, said extract being prepared from a plant biomass from the Labiatae family containing one or more antioxidant compounds, wherein said extract is essentially odorless, flavorless and colorless when used at a concentration between about 5 and 1000 ppm and has an absorbance of about 0.239 absorbance units at 400 mn when 0.1 mL of the extract is diluted with 10 mL of water.

32. A method for stabilizing the flavor of red wine, comprising adding to said wine an effective flavor stabilizing amount of an improved water-soluble plant extract prepared from a plant biomass from the Labiatae family containing antioxidant compounds, said extract being essentially odorless, flavorless and colorless when used at a concentration between about 5 and 1000 ppm and having an absorbance of about 0.239 absorbance units at 400 nm when 0.1 ImL of the extract is diluted with 10 mL of water.

33. A red wine product comprising red wine and an improved water-soluble plant extract in an amount sufficient to stabilize the flavor of said wine, said extract being prepared from a plant biomass from the Labiatae family containing one or more antioxidant compounds, wherein said extract is essentially odorless, flavorless and colorless when used at a concentration between about 5 and 1000 ppm and has an absorbance of about 0.239 absorbance units at 400 nm when 0.1 niL of the extract is diluted with 10 mL of water.
